(19) United States
(12) Patent Application Publication
(10) Pub. No.: US 2020/0211295 A1
(43) Pub. Date: Jul. 2, 2020

(54) METHODS AND DEVICES FOR TRANSITIONING AMONG REALITIES MEDIATED BY AUGMENTED AND/OR VIRTUAL REALITY DEVICES

(71) Applicant: EDX Technologies, Inc., Austin, TX (US)

(72) Inventor: Roger Ray Skidmore, Austin, TX (US)

(21) Appl. No.: 16/678,166

(22) Filed: Nov. 8, 2019

Related U.S. Application Data
(60) Provisional application No. 62/757,949, filed on Nov. 9, 2018.

(51) Int. Cl. G06T 19/20; G06T 19/00

(52) U.S. Cl. CPC G06T 19/20; G06T 2219/028; G06T 19/003; G06T 19/006

(57) ABSTRACT

In an embodiment, a computer-implemented method for modifying a sensory modality which is perceived by a user for a reality mediated by a virtual reality (VR) or augmented reality (AR) device, comprises determining a first viewing frustum of a first reality; aligning the first viewing frustum of the first reality with a second viewing frustum of a second reality; and while maintaining the alignment of the first and second viewing frustums, changing the sensory modality perceived by the user for one or more objects of the first reality to conform with the second reality.

### FIELD OF THE INVENTION

Embodiments of the invention generally relate to changes in reality and, more particularly, systems and methods of changing between types of reality.

### BACKGROUND

Multiple forms of reality exist today, and in increasingly immersive forms. Everyday reality—that is to say what people experience of real surroundings by their natural senses—can now be modified with forms of “mediated reality” (MR) or altogether supplanted with forms of “virtual reality” (VR). A common form of mediated reality is “augmented reality” (AR), by which user's perceive a combination of real world content (i.e., real content) and virtual content. The ability to change perception among everyday reality (referred to herein as “unmediated reality” (UR)), MR, AR, and VR presents problems, however. Changes in perception can be unpleasant and disorientating. For some users of AR/VR devices this is at least an inconvenience. For other users, poor transitions among perceptions can be outright dangerous. Consider for instance AR-induced disorientation of a civilian actively driving a vehicle, a surgeon conducting an operation, or a soldier in the midst of a military operation. A need exists to provide effective and seamless transitions among realities without compromising a user's sense of orientation and surroundings.

### SUMMARY

According to an aspect of some embodiments, a VR or AR device mediates changes in reality using methods of seamless transition. An exemplary device is configured to change its output to take a user from a first reality experience to a second reality experience in a seamless manner.

Exemplary methods may transition among any of a variety of reality types. A method of transition may change a user's experience from an unmediated reality to an augmented reality, from an augmented reality to a virtual reality, from a virtual reality to another virtual reality, from a virtual reality to an augmented reality, from an augmented reality to another augmented reality, from an augmented reality to an unmediated reality, from an unmediated reality to a virtual reality, or from a virtual reality to an unmediated reality.

According to an aspect of some embodiments, one or more user's perception(s) of reality is/are altered based on augmented reality (AR) and virtual reality (VR) outputs. Visual output to a user may be seamlessly transitioned among AR and VR (i.e., AR to VR; VR to AR; or some combination of back and forth switching). Visual output to a user may be seamlessly transitioned among AR, VR, and unmediated reality (UR). One aspect of an exemplary seamless transition is minimal or nonexistent instantaneous change in object location as the perception of the object changes from a real object in AR or UR to a virtual object in VR. For example, if a user is looking at a real world building in AR or UR, the transition to VR substitutes the view of the real world building with a view of a virtual building in such a manner that the user perceives the virtual building as existing at the same location as did the real world building. Another aspect of an exemplary seamless transition is preservation of relative positions among a plurality of objects at least some of which are initially real objects prior to the transition. During the transition from AR or UR to VR, the relative positions among the plurality objects are substantially maintained.

For augmented reality, a user's perspective or vantage point may be restricted based on the user's real world location and position. For example, a 6 foot tall user standing at the northwest corner of a building may only experience an AR from a vantage of 6 feet or less off the ground and from the northwest corner of the building. To change his perspective or vantage the user may have to climb a staircase or walk to a different corner of the building. A seamless transition according to an exemplary embodiment may switch the user's perception of reality from AR to VR without a change in perspective or vantage point. Yet after the transition, the perspective or vantage point within the VR output may be changed freely. For instance, the output may give the user the perception of flying more than six feet in the air, e.g. up higher than the building. Now the user may view a virtual world from any location, from any height. It may be possible to see any of the corners of the building, or from any of the corners of the building.

An advantage of an exemplary seamless transition is minimal or non-existent disorientation of a user. To the user's perception, that which is viewable and real simply changes appearance to a virtual state. Locations, positions, relative positions, orientations, and other aspects of a user's perception may be preserved during the transition. This may be achieved using a virtual model modeling after the real world. Real world objects may be “recreated” in the virtual world as virtual objects with like locations and possibly like appearances.

A seamless transition may be substantially instantaneous or gradual, taking place over a longer period of time.

According to an aspect of some exemplary embodiments, a free transition may require matching viewing frustums among the real world and a virtual model. Changes in visual outputs (to the user) which are part of the transition may only be performed while the real frustum and virtual frustum match. To match, the real frustum and virtual frustum may have identical values for one or more (preferably all) of the following frustum parameters: a position, a vertical field of view, a horizontal field of view, a near limit, and a far limit.

An exemplary use scenario for an exemplary embodiment is in a military operation. One or more soldiers on the ground may require a change in vantage or perspective without changing their physical location. For instance it may be unsafe for a soldier to expose himself or herself from a particular secure or shielded location. Yet, such a soldier may benefit from an ability to see his surroundings from some other vantages points. This may be achieved by looking at a map, or using a virtual reality which may show a top down view of the soldier and the surroundings. Yet, changing a soldier's view without a seamless transition may be disorienting, distracting, or even jarring. Exemplary embodiments overcome these problems by providing a seamless transition of the user's perception from real world content to virtual content, such as a seamless transition from AR to VR.

### BRIEF DESCRIPTION OF THE DRAWINGS

FIGS. 1A and 1B are exemplary methods of free transition.

FIG. 2 is another exemplary method of free transition which may be a subprocess to the method of FIG. 1B.

FIG. 3 is an aerial VR view within a virtual model modeled after the real world.

FIG. 4 is a ground level UR view of a first building.

FIG. 5 is a ground level VR view taken from the virtual model presented in FIG. 3 and aligned with the UR view of FIG. 4.

FIG. 6 is a side-by-side comparison of the UR view of FIG. 4 and the VR view of FIG. 5 to illustrate their alignment.

FIG. 7 is a ground level AR view free transitioned from the UR view of FIG. 4 and using virtual content of the aligned VR view of FIG. 6.

FIG. 8 is another ground level AR view changed from the AR view of FIG. 7.

FIG. 9 is a diagram of an exemplary system.

FIG. 10 is a frustum.

### DETAILED DESCRIPTION

Human awareness of surroundings is produced by the senses, including one or more of sight (vision), hearing (audition), taste (gustation), smell (olfaction), and touch (somatosensation). The perception of stimuli by one or more of these sensory means produces a “reality”. Other sensory means which may contribute to perception of a surrounding environment include but are not necessarily limited to balance (equilibrioception), temperature (thermoception), kinesthetic sense (proprioception), and physiological pain (nociception).

“Mediated reality” comprises one or more stimuli (e.g., visual content output or outputtable with a display device) by which reality is modified (e.g., diminished or augmented), often by a computer. The general intent is to enhance one's natural perception of reality (e.g., as perceived by their senses without external devices). A user experiences both real content and virtual content when experiencing mediated reality.

“Augmented reality” and “diminished reality” are sometimes treated as two different subtypes of “mediated reality” depending on whether the virtual content adds to or substitutes for real content. In this disclosure, this distinction is ignored, with the result the expression “augmented reality” may be used synonymously with “mediated reality”. Simply put, if a system, device or method results in a user experience that contains both real content and virtual content, such result may be called “augmented reality” or “AR”.

AR may comprise active content and/or passive content. Active content may be, for example, a visual output on a display device or an auditory output on a speakerphone device. Passive content may be, for example, visual stimuli from natural surroundings. For instance, on a see-through head mounted display (HMD), the real world is naturally visible to a user through a see-through display surface of the device. Therefore a see-through HMD need only actively display virtual augmentations in order to provide AR content. Real world content is provided but is, in essence, provided passively. Real world content may be provided actively, by for example, capturing real world content with a camera and subsequently displaying the content (e.g., on a screen). The virtual content may be supplied as overlays or otherwise imbedded with the real world video content.

“Virtual reality” replaces the real world with a simulated one. If a system, device, or method results in a user experience that contains only virtual content (i.e., no real content), such result may be called “virtual reality” or “VR”.

In general, AR and VR outputs according to exemplary embodiments may take any of a variety of perspectives, including third-person, first-person, top-down, aerial, elevated, others, or some combination of these.

An “augmentation” is a unit of virtual content and may be, for example, a virtual object rendered as a graphic on a display device. An augmentation may be visual (most common), audial, tactile, haptic, thermal, gustatory, smellable, or some combination of these. For example, an augmentation may comprise or consist of sound, video, graphic, and/or haptic feedback. The term “augmentation” is often used in the context of AR but is not incompatible with use in the context of VR. An augmentation may involve one or more (i.e., at least one) sensory modality. Sensory modalities may be visual, audial, tactile or haptic (e.g., vibration), or olfactoral or gustatory, or any combination thereof, e.g., audiovisual. Augmentations may take the form of, for example, 3D representations of real objects (e.g., a detailed 3D representation of a cell tower), or of abstractions of real objects (e.g., a cell tower represented as a simple cylinder with a sphere at the top), or of indicators or cues (e.g., callout boxes). Some information represented in an augmentation may have no corresponding real world shape. For example, a wireless network link between two wireless network antennas has no real world visible representation, so any augmented presentation of that connection is necessarily some kind of abstraction (e.g., a geometric shape). On the other hand some information represented in an augmentation may have at least one straightforward augmentation that is minimally abstract, e.g., a 3D graphic of a building that is positioned, shaped and colored to be very much like a corresponding real building.

“Real content” includes visual content generally determined from light coming from (e.g., reflected from, transmitted by, or emitted from) real world objects. That which human eyes detect in dependence on sunlight (e.g., sunlight reflected off of the human's surroundings) is a non-limiting example of real content. Artificial light may also contribute to producing real content. Cameras which detect sunlight or artificial light from real world objects to produce images of real surroundings may also be said to produce real content. In such circumstances the cameras function analogously to human eyes, and the visual content produced by the human eye or by the camera is real content.

“Virtual content” is visual content which is not determined from light coming from real world objects. Virtual content is often if not always computer generated. Examples will help differentiate virtual content from real content. If a movie film depicts actors in costumes in essentially the same manner as they would appear on a stage in a theater, the movie film is entirely real content. If the movie film contains computer generated imagery (CGI), the CGI content is virtual content and is not real content. The resulting movie may contain a mixture of real content and virtual content. On the other hand, an animated movie film generally contains no real visual content and therefore may be entirely virtual visual content. Of course an animated film may contain recordings of real voice actors, in which case the audio content may be real content. For many examples in this disclosure, references to “content” may be treated as “visual content” unless the context indicates otherwise.

“Quasi-real virtual content” is a specific type of virtual content. The adjective “quasi-real” is used herein to designate virtual content that copies, replicates, or mimics real content. For any quasi-real thing (say, a virtual building, or a virtual street, or a virtual tree), a corresponding real object of similar or identical appearance exists in the real world. A quasi-real virtual thing may have similar, matching, or identical size, shape, color, texture, contours, and/or other visual quality to a corresponding real thing. In addition, in a virtual model (i.e., virtual world) which mimics a real world environment, a quasi-real virtual object also mimics location and arrangement with respect to other objects and surroundings.

“Unreal virtual content” is another type of virtual content. As used herein, the adjectives “quasi-real” and “unreal” are mutually exclusive. Virtual content cannot be both “quasi-real” and “unreal”. (Of course virtual content can also never be “real” by definition.) Unreal virtual content does not have any corresponding real object of similar or identical appearance existing in the real world.

An example will help differentiate between “quasi-real” and “unreal”. A virtual model of New York City may contain a virtual representation of the real Empire State Building, and the virtual Empire State Building would appear at the same street address or GPS coordinates within the virtual model as the real Empire State Building does in real NYC. In this case the virtual Empire State Building is accurately characterized as a “quasi-real virtual object”. If the virtual Empire State Building is visually present in a view, it constitutes “quasi-real virtual content” within the view. By contrast, if a virtual model of London contained a virtual representation of the real Empire State Building, such virtual Empire State Building would be “unreal” (not “quasi-real”). Despite the Empire State Building existing in the real world, it does not really exist in London. Presenting the virtual Empire State Building out of its real world context (London instead of NYC) qualifies it as “unreal”. If a view of London included the virtual Empire State Building this would be “unreal virtual content”.

Both real content and virtual content may be described as “obstructed” or “unobstructed”. If a thing is not visible to a viewer because some other thing is blocking line of sight, the not visible thing is “obstructed”. When nothing is in the way and there is a clear line of sight, a thing is “unobstructed”. People are accustomed to the idea of one real world object obstructing another real world object. Similarly, a virtual object may obstruct a real object; a real object may obstruct a virtual object; and a first virtual object may obstruct a second virtual object.

“Virtual model” and “virtual world” may be used interchangeably. Since the real world is three-dimensional (3D) to the ordinary perception of humans, a corresponding virtual model may also be characterized as 3D but need not necessarily be so (i.e., a model may be two-dimensional; a model may be four dimensional and include time; a model may be multidimensional with one or more of a plurality of spatial dimensions, a temporal dimension, and other dimensions like color). An exemplary virtual model has virtual locations which are configured to correspond with real world locations. In other words, the virtual model may include a virtual landscape modeled after the real world landscape. Real world geography, locations, landscapes, landmarks, structures, and the like, natural or man-made, may be reproduced within the virtual world in like sizes, proportions, relative positions, and arrangements as in the real world. For example, an exemplary 3D virtual model of New York City would in fact resemble New York City in many respects, with matching general geography and landmarks. Within the virtual world, virtual objects may be created (e.g., instantiated) at virtual locations. Since a virtual location corresponds with a real world location, a virtual object at a given virtual location becomes associated with a particular real world location that corresponds with the given virtual location.

The virtual world containing and storing the virtual objects which are employed for generating AR content may be a 3D virtual representation of the real world which may be stored as data in one or more databases (e.g., a central database or a distributed network). Such databases or networks may store, for example, geometric aspects of the virtual representations and characteristics of the objects which are instantiated within that virtual representation.

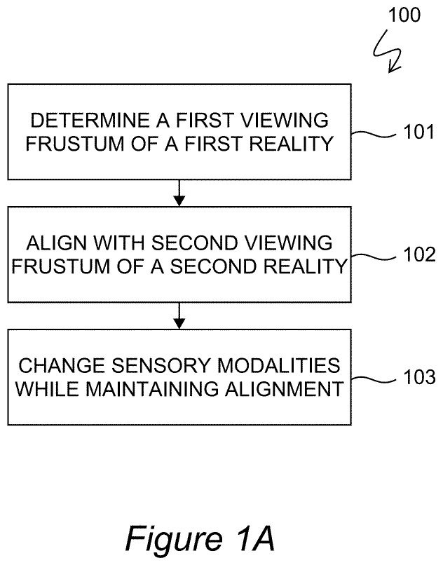

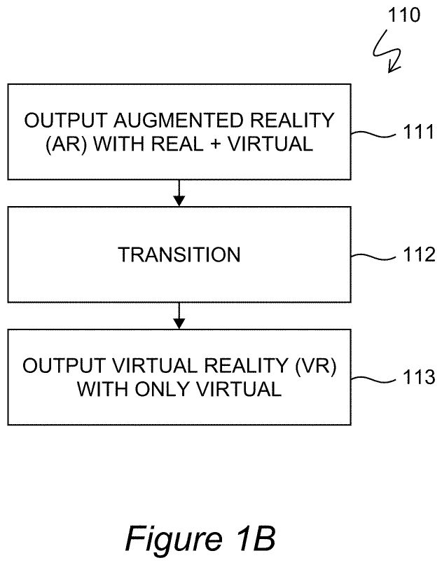

FIG. 1A shows an exemplary method 100 for switching among realities. The method 100 may be performed by a virtual reality (VR) and/or augmented reality (AR) device or a system that includes such a device. At block 101, a first viewing frustum of a first reality is determined. At block 102, the first viewing frustum is aligned with a second viewing frustum of a second reality. At block 103, while maintaining the alignment of the first and second viewing frustums, one or more sensory modalities are changed (e.g., altered) for one or more objects of the first reality to conform to the second reality.

FIG. 1B shows an exemplary method 110 for a free transition among AR and VR. For ease of understanding, the figure and explanation will refer to a transition from AR to VR (though other transitions, like VR to AR, may be realized by substantially the same method). According to an exemplary embodiment, a method 110 of altering a user's perception of reality may comprise displaying at a first time an augmented reality (AR) comprising both real world content and virtual content (block 111), displaying at a second time a virtual reality (VR) consisting (by definition) of only virtual content (block 113), and seamlessly transitioning from the AR to the VR between the first time and the second time (block 112). The first and second times may be only a moment apart, in the event the seamless transition is substantially instantaneous. Alternatively the first and second times may be spaced apart some matter of seconds or minutes, in the event the seamless transition is gradual. In some cases the seamless transition may be the reverse, from VR to AR instead of AR to VR. In some cases multiple seamless transitions may be made.

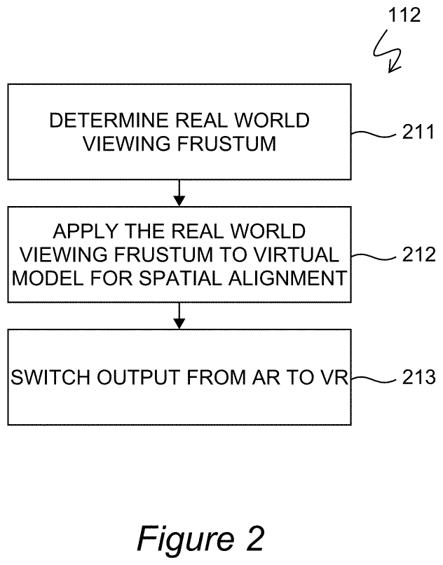

FIG. 2 shows an exemplary subprocess for performing the seamless transition 112 of method 110. According to an exemplary embodiment, the seamless transition 112 may comprise determining a first viewing frustum of one or more user's at the first time (block 211), applying the real world viewing frustum to a virtual model configured to correspond with the real world so that at least some virtual objects spatially align with real objects (block 212), and switching display from AR to VR after the alignment is achieved and while the alignment remains true (block 213). After the seamless transition the vantage point of a user (or users) may be changed. For example, the vantage may be changed beginning with a first person ground view and transitioning to a third person aerial view in the VR.

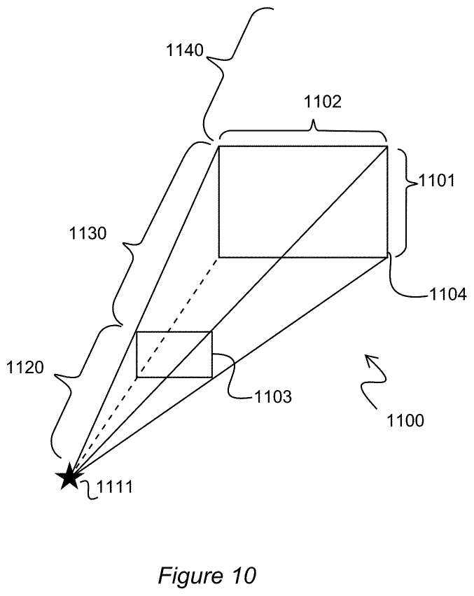

“Frustum” may be used to refer to a visible region of three-dimensional space. A real world setting may involve a camera, whereas a virtual world setting may involve a viewpoint (e.g., a virtual camera). In the context of digital spaces (e.g., virtual reality worlds), field of view (FOV) is frequently discussed according to a viewing frustum. FIG. 10 shows an example of a viewing frustum 1100, referred to herein simply as “frustum.” Because viewports are frequently rectangular, the frustum is often a truncated four-sided (e.g., rectangular) pyramid. For viewports of other shapes (e.g., circular), the frustum may have a different base shape (e.g., a cone). The boundaries or edges of a frustum 1100 may be defined according to a vertical field of view 1101 (an angle, usually expressed in degrees), a horizontal field of view (an angle, usually expressed in degrees), a near limit (a distance or position), and a far limit (a distance or position). The near limit is given by a near clip plane 1103 of the frustum. Similarly, the far limit is given by a far clip plane 1104 of the frustum. Besides these boundaries, a frustum may also include position and orientation. In short, an exemplary frustum may include position, orientation, field of view (horizontal, vertical, and/or diagonal), and near and far limits. In a digital space, virtual objects falling in the region 1120 between the viewpoint 1111 and the near clip plane 1103 may not be displayed. Likewise, virtual objects falling in the region 1140 which are beyond the far clip plane 1104 may not displayed. Only virtual objects within the frustum 1100, that is to say within the region between the near and far clip planes 1103 and 1104 and within the horizontal FOV 1102 and vertical FOV 1101, may be candidates for representation by augmentation. This differs from a real world view of a camera, where visibility of an object is generally based on horizontal FOV 1102 and vertical FOV 1101 only. That is to say, for a camera in a real world setting, real objects which are within the horizontal FOV 1102 and vertical FOV 1101 are generally visible. In a digital space, a near clip plane 1103 may be set to zero (i.e., at the viewpoint) and a far clip plane 1104 may be set to infinity or substantially infinite distance in order to approximate the view from a camera looking upon the real world. However, omission of objects closer than a virtual camera's near clipping plane (which would ordinarily be out of focus for a real camera), and of objects beyond its far clipping plane (which would for a real camera appear so tiny as to be effectively invisible unless their physical dimensions are quite large) is performed as an efficiency gain in a virtual system. A virtual camera's near clipping plane may be placed arbitrarily close, and the far clipping plane arbitrarily far, if an augmented reality system is willing to do the extra processing required to render the resulting increased volume of the frustum. In any case a frustum may generally correspond with a real camera's field of view. It should be understood that obstruction of one object by another as well as object diminution at great camera-to-object (viewpoint-to-object) distances may result in reducing or eliminating visibility of an object even though it technically exists within a frustum 1100.

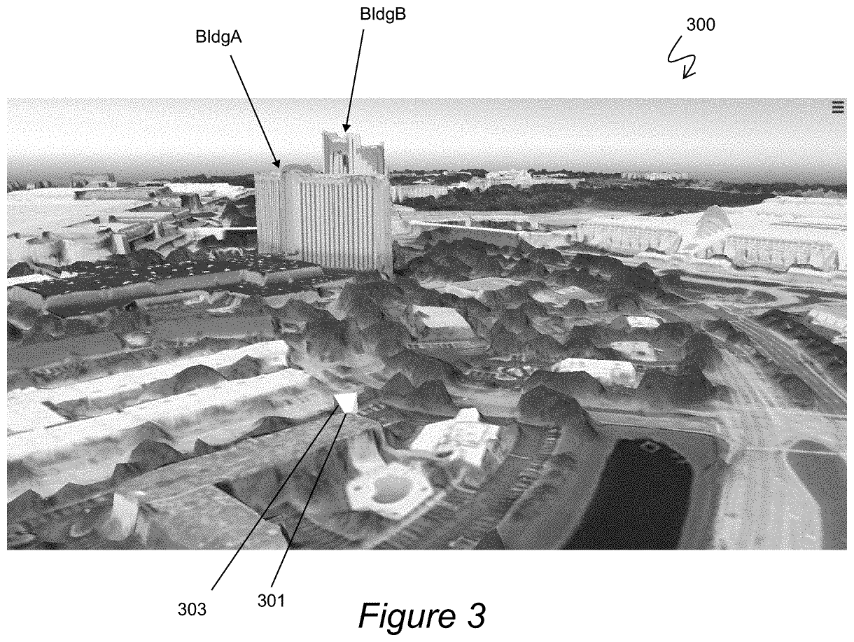

FIGS. 3 to 6 illustrate exemplary outputs in connection with a free transition method (like method 100 of FIG. 1A). FIG. 3 is a view 300 within a virtual model. One hundred percent of what is shown in the view 300 is virtual content of the virtual model (lead arrows and labels being additional labeling for purposes of this description). The virtual model of view 300 is modeled after the real world. At least with respect to the content visible in view 300, the virtual content is all pseudo-real virtual content. Specifically, the roads, parking lots, landscaping, buildings, swimming pool, high rise buildings, etc. which appear in view 300 are virtual representations of corresponding real roads, parking lots, landscaping, buildings, swimming pool, high rise buildings, etc. with like appearances, locations, and arrangement with respect to one another (i.e., relative arrangement). The virtual model may contain unreal virtual content as well, but none is shown in view 300.

FIG. 3 is labeled to indicate a location 301 of a viewer and that viewer's viewing frustum 303. From the figure it is apparent that the viewing frustum 303 faces in the direction of two buildings, respectively identified and labeled as BldgA and BldgB.

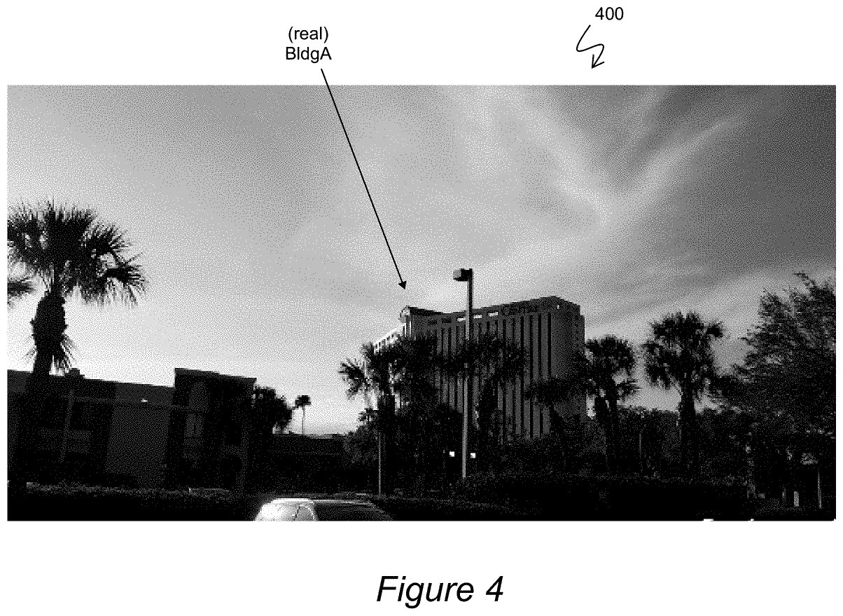

A real world user, such as a person, may be standing at the real world location which matches the location 301 in the virtual model. FIG. 4 shows such a user's unmediated reality (UR) view 400. The user has an unobstructed view of real BldgA. Though the user faces in a direction of BldgB, the user's view of BldgB is obstructed by BldgA (see FIG. 3 for illustration of how BldgA lies between the location 301 and BldgB).

Beginning with the UR view 400 of FIG. 4, the user may be desirous of transitioning to one or more mediated reality (MR) and/or virtual reality (VR) views, and embodiments of the invention may provide this functionality according to a seamless transition (i.e., “free transition”) method. A device or system may be provided to perform the transition. Such device or system may be configured to permit output to the user containing real content, virtual content, or a combination of both. Exemplary devices for this purpose include head mountable displays (HMDs) as well as a variety of electronic devices (especially mobile electronic devices) such as a smartphone, tablet, wearable, or laptop. A see-through HMD may passively permit viewing of real world content and produce virtual content as overlays to the real content. Other HMDs and other electronic devices may use one or more cameras to reproduce real world content on a screen together with any virtual content.

Virtual content for populating either MR or VR views may be sourced from the virtual model that was depicted in FIG. 3. Before displaying virtual content to the user, however, the device or system first aligns the real world view 400 with a corresponding virtual world view 500. Briefly, parameters of the real world frustum are determined, applied to the virtual model, and the resulting view within the virtual model provides the basis for selecting what to output to the user.

Alignment of views 400 and 500 may be performed without any visual output, e.g., with only computational decision making by one or more computers with one or more processors (e.g., of an HMD and/or mobile electronic device and/or of a cloud computing system).

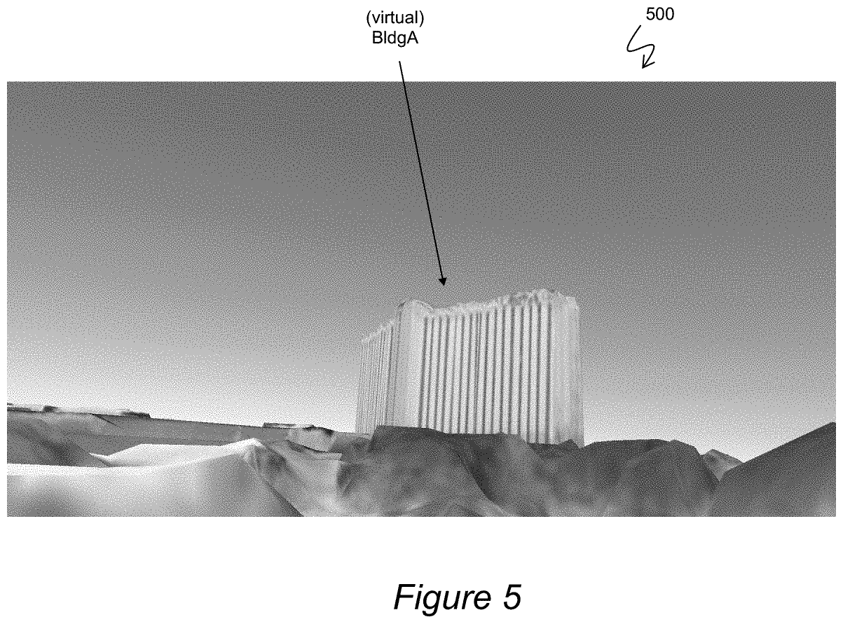

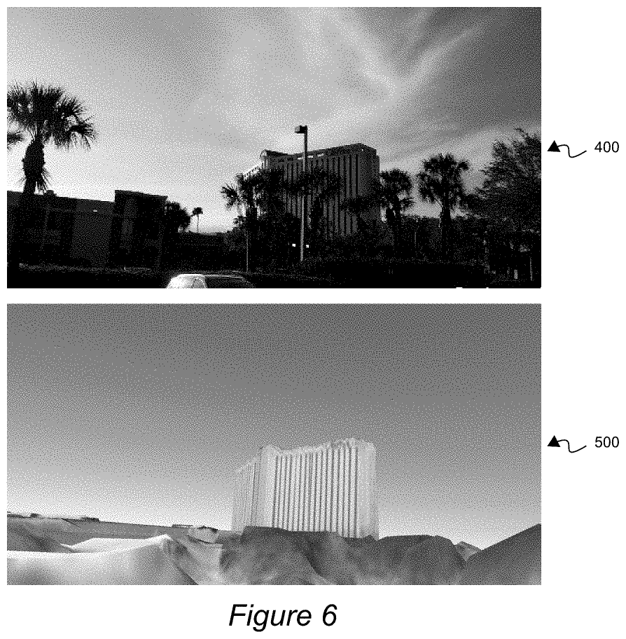

Once the UR view 400 and VR view 500 are aligned, a transition may begin. Prior to alignment no transition should generally be initiated. As apparent from FIGS. 4 and 5, alignment brings the view of real BldgA (in view 400) into substantially the same conditions as the view of virtual BldgA (in view 500). For convenience to the reader of this disclosure, FIG. 6 presents a side by side comparison of UR view 400 and VR view 500. BldgA is at substantially the same apparent location and with the same apparent arrangement (relative distances, sizes, proportions, etc.) both in the real world view and in the virtual view. The substantial correspondence of the real objects and virtual objects from the view 400 and the view 500 exemplifies alignment. Alignment need not be exacting in every case, and tolerances or margins of error accepted within the field are to be understood as implied when saying two things are aligned. Ultimately, a would-be user's perception of consistency drives the parameters of alignment and be used to define a threshold between alignment and non-alignment.

A seamless transition from UR to VR may be achieved by an instantaneous switch from view 400 to view 500. A gradual transition may also be performed, but only so long as the user maintains a viewing frustum corresponding to what is shown by frustum 303 in FIG. 3 (at least according to an exemplary embodiment).

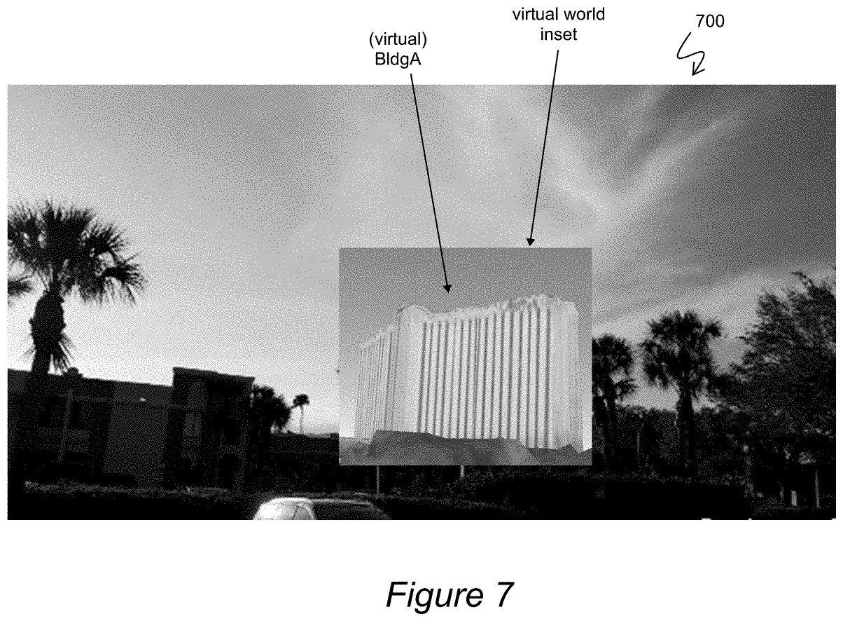

A seamless transition from UR to AR may be achieved by replacing portions of the UR view 400 with portions of the VR view 500. AR view 700 of FIG. 7 is one such exemplary output. In AR view 700, a virtual world inset is displayed over corresponding real world content. Virtual BldgA is now displayed to a user instead of real BldgA. The virtual BldgA of view 700 is quasi-real virtual content, since the virtual content shown mimics the real content which would otherwise be present (see UR view 400 for comparison).

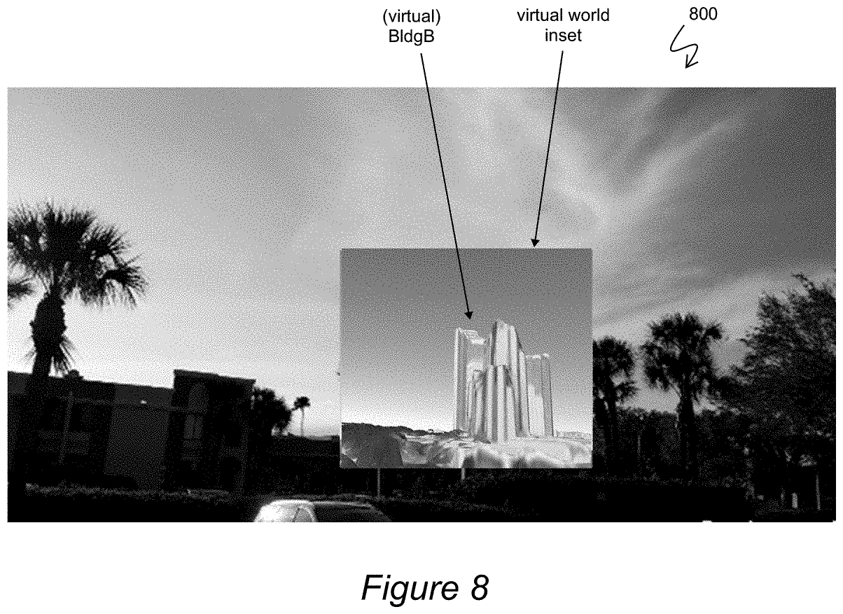

From AR view 700, further seamless transition to other AR views is possible. AR view 800 in FIG. 8 is one such example. In this case, the virtual world inset is changed. In AR view 800 a virtual world view extending behind BldgA is inset. From a visual standpoint, BldgA has been removed, and with it the obstruction it presented to BldgB. As a result virtual BldgB is output in the AR view 800. Like virtual BldgA, virtual BldgB is quasi-real since it mimics a real BldgB.

The use of quasi-real virtual content is important to many seamless transitions. Quasi-real virtual content may provide a transitional content that bridges otherwise stark contrasts between real content and unreal virtual content.

In an aspect of some embodiments, methods or devices are configured to allow for changing the perspective of the user in the “real world” to a different position/orientation, and in connection thereto, adjusting the user's view in a virtual world to match the corresponding position/orientation of the virtual world with that of the real world.

As an illustrative example, a user is wearing a head mounted display. The user looks around. The user sees a real building. Through a user interface (UI) of the AR/VR device, the user is able to select the rooftop of the building. The user's current view is then immediately shifted into the perspective in the virtual world as if the user was standing on the rooftop. As the user “looks around,” the orientation of her view shifts but is kept in sync with the virtual model. From the perspective of the user, her view is now as if she is looking around from the rooftop of the building, with the view being of the virtual model.

Embodiments may also account for user movement. Exemplary methods may match actual movement in the real world with perceived movement in the corresponding virtual world. To continue the example of the preceding paragraph, if the user walks 10 feet to the right in the real world, from her perspective she has walked 10 feet to the right on the rooftop of the building in the virtual world.

In some embodiments there may be a complete separation of the position and orientation of the user to allow for a freeform “fly through” of a virtual model.

A user's viewing frustum may correspond with the viewing frustum of a camera or cameras of an AR device which captures real world image data describing the user's real world surroundings. A real world frustum may be determined based on one or more of, for example, a present location (e.g., of the AR device), a field of view (e.g., of the AR device's camera), an orientation (e.g., of the AR device's camera), a position (e.g., of the AR device or camera), a pose (i.e., a combination of position and orientation), and assumptions about the near and far field limits (e.g., predetermined values for near and far field limits).

When a real world frustum is applied to the virtual world of the 3D virtual model, essentially, the real world frustum is used to set the viewing frustum within the virtual world. Virtual objects which are inside the (now virtual) viewing frustum are found as candidates for augmentation. Virtual objects lying entirely outside the viewing frustum are not candidates for augmentation.

A signal may be initiated to direct or control the augmented reality output of an output device. The output device may simply be the original AR device for which the viewing frustum was previously determined. Depending on where the signal originates, it may be transmitted over a network such as one or more wireless networks and/or the Internet. In this way, processing may be performed on one or more remote computers (e.g., servers) of one or more cloud network, with output still being served to an end user on a network connected AR device. Alternatively, a single end-user device may be configured to perform much or all of an exemplary method, in which case the initiated signal may be initiated by a processor of the device and transmitted over a hardware connection to an output element such as a display (e.g., digital screen).

An augmented or virtual reality is ultimately output to the user. Here, the signal previously generated is used by an output device such as a head mounted display (HMD) or a digital display to show the augmentations together with real world content, or else VR with all virtual content.

Perspective information characterizing the real world content of an image or video to be augmented may be collected or simply received. Generally, a GPS sensor, digital compass, and gyroscopic sensors, for example, may be used to collect the 3D position and orientation of a camera co-located with such sensors. A 3D real world frustum is determined based on the 3D position and orientation of the camera, and on assumptions about the near and far field limits. These limits may be set to default values, for example. The real world frustum is applied to the virtual world and thus determines which virtual objects are candidates for augmentation into the original camera images. Virtual objects which are in the viewing frustum may be viable candidates, whereas virtual objects outside the viewing frustum may not. Selection is made of augmentations based on the virtual object candidates. Augmentations are the actual virtual content added to real world content and which may be consumed by a user viewing the AR output. The selection may involve one or more criteria including, for example, user option selections and the relationships between different virtual objects. For instance, one or more processors may determine which of the virtual objects obscure parts of each other based on the frustum in the virtual world. The final augmentations may then be applied to the image or frame containing real world content and output. The process according to some embodiments may involve little or no image processing whatsoever. In some cases image processing may also be used, however.

A “camera” as used herein may be digital, analog, or have elements of both camera types. A camera may capture still images or photographs. A camera may capture video (i.e., a video camera). A camera may capture both still images and video. A camera may technically be a combination of cameras the plural outputs of which may be combined to form a single image or video. Generally, a camera includes at least one lens and an image sensor. The lens focuses light, aligns it, and produces a round area of light on an image sensor. Image sensors are typically rectangular in shape, with the result that the round area of light from the lens is cropped to a standard image format. A lens may be a zoom lens or a fixed focal length lens. As of 2017, most mobile multipurpose electronic devices had fixed focal length lens. However, embodiments of the invention may be suited for either type of lens or lenses developed in the future. Photographs or videos captured by a camera may be stored digitally, e.g., with pixel values stored on a computer readable medium. Additional sensors besides the optical elements may be used to collected additional information associated with the captured image(s) or video(s) such as but not limited to location (e.g., GPS coordinates), position, and orientation. Such information may be treated as metadata to a captured image or video.

Augmented reality may involve defining spatial relationships between virtual objects and real objects, and then making the virtual objects apparent to a user of the augmented reality system in such a way as to combine real and virtual objects in semantic context. For example a visual augmented reality display could use virtual and real objects, and their defined spatial relationships, to generate a combined visual display in the form of a live streaming video (presenting real objects) overlaid with representations of the virtual objects. A spatial relationship between two objects (either or both of which may be virtual or real) may involve one or more of a topological relation, a distance relation, and a directional relation. A topological relation between an object A and an object B may be, for example, A is within B, A is touching B, A is crossing B, A is overlapping B, or A is adjacent to B. Precise spatial relationships between real and virtual objects allow an augmented reality system to generate perceptual experiences in which real and virtual objects are apparently combined seamlessly, e.g. for visual systems the combined presentation is apparently in the correct visual proportions, perspectives, and arrangement. Without correct reckoning of the spatial relationships in such a system, errors in the presentation of the system's output to the user can cause the system to be unusable, e.g. virtual objects appear out of place and therefore are not useful. An example is a virtual visual label that should label one building, but is erroneously shown overlaid onto a different building.

In order to create a visual augmented reality system, in addition to establishing spatial relationships between virtual objects and real objects, the visual perspective into the real world must be matched to the effective visual perspective into the virtual world. Even when the virtual world objects are sized and positioned correctly with respect to their real world counterparts, the determination of which virtual objects are eligible for visual presentation to the user depends on the perspective in the virtual world, which must be matched to the real world perspective of a real world camera in order to take advantage of carefully determined spatial relationships among virtual and real objects. The perspective of a camera may include the position of the camera, the orientation of the camera, and its field of view. One or more of these variables may be used to align a real world view with a virtual world view.

The need for a correctly matched perspective between virtual and real worlds means that in order to provide an accurate spatial relationship between virtual objects and real objects in an augmented reality output, it is necessary to determine aspects of the camera's surroundings. In many AR systems, a camera's surroundings are determined using image processing, including object or feature recognition. Objects or features of a real world image are extracted and matched to reference databases containing data that describes known object or features. A convolutional neural network is an exemplary means for performing image processing and identifying objects or features in the image. In exemplary embodiments herein, image processing may or may not be used. Excluding image processing in the conventional sense may have the advantage of significantly reducing processing resources (e.g., computing time, energy, hardware, and time).

A camera's context and surroundings are also dependent on such variables as the camera's location, the camera's orientation, the camera's pose (i.e., the position and orientation together), and the camera's field of view. In some known AR system, some or all of these variables are ignored entirely, the known systems relying predominantly or entirely on image processing like object recognition algorithms.

In order to create a visual augmented reality system, in addition to establishing spatial relationships between virtual objects and real objects, the visual perspective into the real world must be matched to the effective visual perspective into the virtual world. Even when the virtual world objects are sized and positioned correctly with respect to their real world counterparts, the determination of which virtual objects are eligible for visual presentation to the user depends on the perspective in the virtual world, which must be matched to the real world perspective of a real world camera in order to take advantage of carefully determined spatial relationships among virtual and real objects. The perspective of the camera may include the position of the camera, the orientation of the camera, and its field of view.

As used herein, “time” may refer to a day of the week, a calendar day, a clocktime (e.g., identified by the hour or by hours and minutes per a 12 hour or 24 clock), a general time of day (e.g., morning, afternoon, evening, night), a holiday, a season (e.g., fall, winter, summer, spring), a time zone, a year, a decade, a century, some combination of these, and/or some other commonly understood characterization of time.

One or more processors may conduct processing that determines which augmentations should be added to a specific real world view, and as a corollary what augmentations should not be added to that view. There are multiple aspects of a real world view that may affect such a determination. A first aspect is the relationship between the viewing device (e.g., a camera) and an “object” of interest. The spatial relationship between the two objects may involve one or more of a topological relation, a distance relation, and a directional relation. A topological relation between an object A and an object B may be, for example, A is within B, A is touching B, A is crossing B, A is overlapping B, or A is adjacent to B. Precise spatial relationships between real and virtual objects allow an augmented reality system to generate perceptual experiences in which real and virtual objects are apparently combined seamlessly, e.g. for visual systems the combined presentation is apparently in the correct visual proportions, perspectives, and arrangement. Virtual content that has been combined with real world content in this manner may be characterized as being in semantic context with the real world objects or real world view.

It should be appreciated that augmentations that are or include auditory and tactile elements still involve virtual objects that need to be identified with accurate spatial relationships with respect to real world objects. For example, a VR device that is an HMD may be used to give a guided tour of a real place like New York City. When a user looks at the Empire State Building with the HMD, the device may announce through a speaker “You are looking at the Empire State Building.” This announcement is an auditory augmentation corresponding with a virtual object that has a location in the virtual world which matches the location of the actual Empire State Building in the real world. Without a determination of the field of the view of the VR device (more specifically the FOV of its camera or cameras), the device conceivably could announce to a user that the Empire State Building is visible when in fact it is just outside of the actual field of view.

In embodiments of the invention, illustrated and described steps may be configured as a greater or fewer number of steps compared to those which are shown. The exemplary methods shown may also be performed or organized with further substeps.

Virtual objects of a virtual world may be stored and manipulated as data within one or more databases. The virtual objects may have their own existence separate from how they are displayed, visualized, haptically buzzed, or otherwise output by an output device. So, generally speaking, a virtual object has its own characteristics, and then, based on those characteristics and on the real and the virtual environment, an exemplary augmented reality system determines what is presented to the user. If a given virtual object is obscured, then it may not be presented to the user as an augmentation. On the other hand, if the system determines that a given virtual object should be visible to the user given the viewing device's position and orientation in the real world and therefore its position and orientation in the virtual world, an augmentation may be displayed (or otherwise provided).

An augmentation may correspond with a virtual object that has a specific location in a virtual world. The virtual world is characterized by a number of locations which correspond with real locations which appear in an image or frame of the real world. In essence, a virtual world (e.g., a virtual model of the real world) is populated with virtual objects corresponding with either or both seen real world objects and unseen qualities of the real world (e.g., data connection paths between cell towers of a mobile network). A virtual world view is characterizable with a frustum. A frustum includes position, orientation, filed of view, and near and far limits of the field of view. A real world view is similarly characterizable, except that in a real world view there is technically no hard limit on near and far limits of field of view.

As a concrete example, an image of a real world view (i.e., a real world image) may include within its field of view a building with a typical rectangular shape. The building has a particular GPS location. More specifically, each of the four corners of the building that touch the ground has its own GPS coordinates. In a corresponding virtual world, a virtual object in the form of a rectangular prism may exist at coordinates which align with the real world GPS coordinates. The virtual object (in this case the rectangular prism) if displayed in an augmented reality would align with the real building in any augmented view so that the two objects—the real world object and the virtual object, align, one superimposed on the other.

Some augmentations are or include a solid 3D model rendered within the context of the real world image. Some augmentations are subject to be changed or replaced or substituted entirely over time. Some augmentations are animations superimposed on the real world image. For example, an augmentation may be a scaled 3D model or animation that is played based on some event. Animations may be triggered (e.g., macroed) based on such an event.

An exemplary system may comprise at least one camera, one or more AR-enabled output devices, and one or more processors configured to execute computer-readable program instructions which, when executed by the processors, cause the processors to perform steps such as those of methods discussed herein. Cameras may be standalone devices or components within multifunction devices which are image capture enabled (e.g., smartphones, tablets, computers, etc.). Elements may be components to the same device or physically independent of one another.

Images/videos captured at some time in the past, previously modified or augmented images/videos, virtual worlds, and/or virtual objects thereof may be stored in individual AR devices and/or in remote databases and/or according to a distributed network of storage resources (e.g., peer-to-peer systems).

AR and VR devices and AR-enabled and VR-enabled devices may take a variety of forms with varying amounts of hardware versus software. Some commercial examples are Microsoft HoloLens, Sony SmartEyeglass, Google Glass, and Vuzix M100 Smart Glasses. Some AR devices may be embodied as virtual reality (VR) headsets. Commercially available examples include Oculus Rift, HTC Vive, and Sony PlayStation VR (Project Morpheus). In the case of VR headsets, AR may be produced by displaying a real world camera's feed to a user as the base image. AR engines may be embodied simply in software. For instance, the software which supports Microsoft HoloLens may be characterized as an AR engine, independent of the physical headset a user must wear to experience the output of the AR engine. Electronic devices like smartphones, personal computers, and servers (both general purpose as well as special purpose) may also be configured as AR engines.

In some embodiments, an exemplary input device comprises, at a minimum, means for capturing information about real world surroundings. Generally the means for capturing information is an optical device, more specifically a camera. The type and number of cameras may vary among embodiments, including visible-light sensitive cameras and night vision (infrared) cameras, among others. Other data besides visual data may be collected to describe real world surroundings. For instance, embodiments may comprise additional sensors such as but not limited to any combination of the some or all of the following: accelerometer(s), location sensor(s) (e.g., GPS modules), gyroscope(s), magnetic field sensor(s) or magnetometer(s), proximity sensor(s), barometer(s), thermometer(s), and microphone(s). The sensors collect the type of data of their respective types (e.g., magnetometer collects magnetic field data or compass data, microphone collects audio data, etc.).

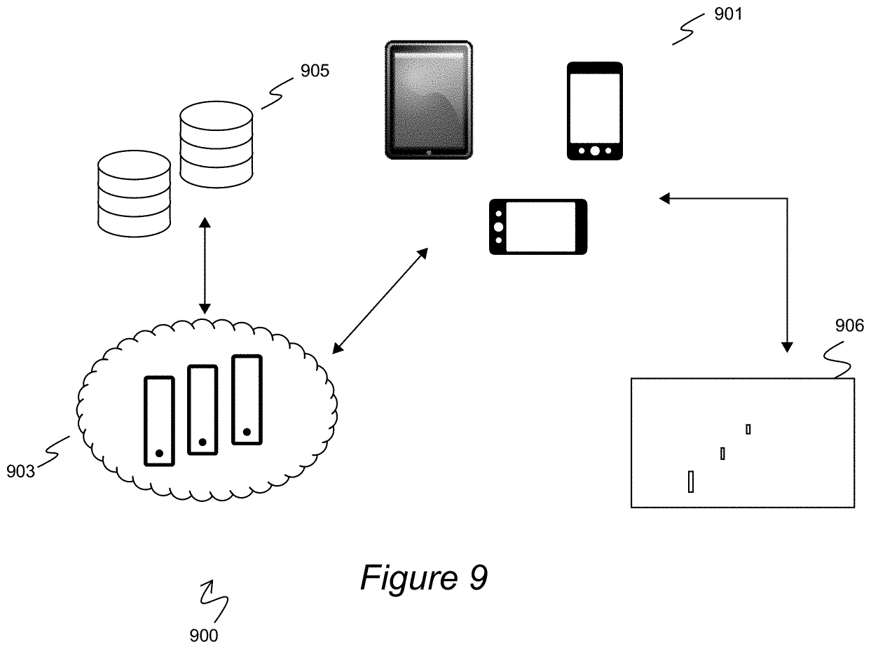

Exemplary processes are generally carried out by some combination of hardware, software, and firmware, either in a particular electronics device or by a system of electronic devices. FIG. 9 is a schematic of an exemplary system 900 for providing an augmented reality. Electronic devices 901 may include sensors for collecting data about a user's physical location and pose (position and orientation). In particular, the data may reflect the location and pose of a device 901 itself. The devices 901 may comprise one or more cameras for capturing a real world view of a geographic space. The captured/collected data may be sent to the cloud 903 (e.g., processors of one or more geographically remote servers) for data processing (e.g., frustum determination, application of real world frustum to virtual world, virtual object candidate identification, augmentation selection, augmentation modification, etc.). In addition or as an alternative to a centralized cloud-based system, processors involved in performing steps of processes of the invention may be part of a decentralized system, e.g. an ad hoc system that varies from one embodiment or even one user to the next, at least in terms of the particular hardware providing the computational power for carrying out the described methods. Databases 905 (which may be one database or many) provide permanent or semi-permanent storage and retrieval for network relevant data, virtual world geometric data, other virtual world data, virtual object data, and essentially every other data discussed herein which is not being newly collected from the sensors and cameras which may be deployed in the field. It should be appreciated that the various data types discussed herein which are generally stored in the databases, in particular virtual object data, may be updated over time when new data becomes available or existing data becomes outdated or expired. Virtual objects and augmentations based on those virtual objects may be correspondingly updated. The processors may use an image or video feed from the devices 901 and sensor data, in particular location data, to generate other data. Augmented image data may be sent back to the devices 901 (or other output device as appropriate) which generates the augmented image 906 on its display device.

An “output device”, as used herein, may be a device capable of providing at least visual, audio, audiovisual, or tactile output to a user such that the user can perceive the output using his senses (e.g., using her eyes and/or ears). In many embodiments, an output device will comprise at least one display, at least one speaker, or some combination of display(s) and speaker(s). A suitable display (i.e., display device) is a screen of a mobile electronic device (e.g., phone, smartphone, GPS device, laptop, tablet, smartwatch, etc.). Another suitable output device is a head-mounted display (HMD). In some embodiments, the display device is a see-through HMD. In such cases the display device passively permits viewing of the real world without reproducing details of a captured real world image feed on a screen. In a see-through HMD, it is generally be only the augmentations that are actively shown or output by the device. Visual augmentations are in any case superimposed on the direct view of the real world environment, without necessarily involving the display of any of the original video input to the system. In fact, for systems which do not use the video input to detect image data, the system may include one or more HMDs that have no camera at all, relying entirely on other sensors (e.g. GPS, gyro, compass) to determine the relevant augmentations, and displaying them on otherwise transparent glasses or visors. Output devices and viewing devices may include or be accompanied by input devices (e.g., buttons, touchscreens, menus, keyboards, data ports, etc.) for receiving user inputs.

A virtual object stored in, with, or with reference to a virtual model may not inherently take a particular state as far as sensory modalities are concerned. For example, a virtual object may not have a particular appearance. Indeed, a virtual object may have no appearance at all, and in essence be “invisible” to an unaided human eye. By contrast, an augmentation is by definition perceptible according to one or more sensory modalities. That is, an augmentation may be seen, heard, touched, smelled, and/or tasted. An augmentation may be regarded as the “face” of a virtual object, in which case data stored in, by, or with the virtual object is used to determine what the augmentation portrays or signifies to a user looking upon that “face”.

“User,” as used herein, may be an entity which employs a method, device, or system of the invention. A user may be a human, multiple humans, or some other entity. A user may be, for example, a person intended to consume AR content generated in accordance with a method or variant of a method disclosed herein.

“User” may be an entity that uses a part or a whole of the invention. “End user” herein is generally a subset of “user” and implies the entity actually consumes some output of an embodiment, such as an augmented reality output. Often consumption comprises viewing, but it may also or alternatively involve hearing, feeling, tasting, or smelling (the latter two being uncommon forms of consuming AR at the time of the invention but within the scope of possible AR consumption contemplated by the invention). “User” may refer to a human interacting with or using an embodiment of the invention. A user may be a group or classification of multiple users. A user or users may be characterized according to any of a number of characteristics. For example, a user may be characterized by a classification, a type, an age, an access level, a demographic, a status, a customer status, a profession, or some other quality. A user may be a person, a thing, a computer, a software program, an artificial intelligence, a work group, a company, a corporate division, a maintenance crew, a content creator (e.g., a user that captures real world content, or a user that creates virtual content), a content consumer, a content editor, a programmer, a subscriber, and/or some other entity. The expression “per user basis” may be used in reference to any such user listed here or some other user not listed here but meeting the definition of “user” herein provided.

“Perspective” as used herein may refer to one or more of location, orientation, pose, position, and field of view. If the image or video is a composite from multiple cameras, information for each of the cameras or a representative camera may be used. Exemplary perspective information includes a location and an orientation. Thus, at minimum, this would describe the camera's view with respect to the location from which the image or video is taken and a direction in which the camera was facing to capture the real world content contained in the image or video.

“Position” and “location” are similar terms and may sometimes (but not necessarily always) be used interchangeably in the art. “Location” is especially prevalent when used in the context of geography or a system of reference used for describing geography (e.g., GPS). “Position” is more common in the context of coordinate systems generally, especially those which are fairly independent of geography (e.g., the Cartesian coordinate system). Both “position” and “location” may be expressed as a point. Unlike “position” however, “location” may be expressed as a region, space, or area. For example, a street corner may be a location, or an entire town may be a location.

“Location” and “position” may be used to refer to a place where something is, e.g., in a Cartesian coordinate system (or some other coordinate system). As compared with orientation, location may be characterized as linear position whilst orientation may be characterized as rotational position. Location information may be absolute (e.g., latitude, longitude, elevation, and a geodetic datum together may provide an absolute geo-coded position requiring no additional information in order to identify the location), relative (e.g., “2 blocks north of latitude 30.39, longitude −97.71 provides position information relative to a separately known absolute location), or associative (e.g., “right next to the copy machine” provides location information if one already knows where the copy machine is; the location of the designated reference, in this case the copy machine, may itself be absolute, relative, or associative). Absolute location or position involving latitude and longitude may be assumed to include a standardized geodetic datum such as WGS84, the World Geodetic System 1984. In the United States and elsewhere the geodetic datum is frequently ignored when discussing latitude and longitude because the Global Positioning System (GPS) uses WGS84, and expressions of latitude and longitude may be inherently assumed to involve this particular geodetic datum. For the present disclosure, absolute location or position information may use any suitable geodetic datum, WGS84 or alternatives thereto.

“Orientation” may be a rotational position (whereas location may be a linear position). Orientation may also be referred to interchangeably as attitude. Even when constrained to a single location, an object may physically take any of a variety of orientations unless further constraints are in place. Orientation may be expressed according to a direction (e.g., a unit vector). Location and orientation together may describe an object according to the six degrees of freedom in three dimensional space.

“Pose” is a term which may be used to refer to position and orientation in the collective.

Field of view (FOV) is the extent of the observable world seen at a given moment, e.g., by a person or by a camera. In photography, the term angle of view (AOV) is more common but can be used interchangeably with the term field of view (FOV).

Angle of view is one significant camera configuration. A camera is only able to capture an image or video (e.g., a series of images) containing an object if that object is within the angle of view of the camera. Because camera lenses are typically round, the angle of view of a lens can typically be expressed as a single angle measure which will be same regardless of whether the angle is measured horizontally, vertically, or diagonally. Angle of view of a camera, however, is also limited by the sensor which crops the image transmitted by the lens. The angle of view of a camera may be given horizontally, vertically, and/or diagonally. If only a single value is given with respect to a camera's FOV, it may refer to a horizontal angle of view.

Angle of view is related to focal length. Smaller focal lengths allow wider angles of view. Conversely, larger focal lengths result in narrower angles of view. For a 35 mm format system, an 8 mm focal length may correspond with an AOV of 180°, while a 400 mm focal length corresponds with an AOV of 5°, for example. As an example between these two extremes, a 35 mm focal length corresponds with an AOV of 68°. Unaided vision of a human tends to have an AOV of about 45°. “Normal” lenses are intended to replicate the qualities of natural vision and therefore also tend to have an AOV of about 45°.

Angle of view is also dependent on sensor size. Sensor size and angle of view are positively correlated. A larger sensor size means a larger angle of view. A smaller sensor size means a smaller angle of view. For a normal lens, FOV (or AOV) can be calculated as

$$FOV = {tan}^{- 1} ( \frac{d}{2 f} )$$

where d is the sensor size and f is the focal length.

In some embodiments, one or more processors (e.g., of the device or system that includes the initial camera, or of an AR engine or AR-enabled device) are configured to use some combination of some or all of the following to determine which virtual objects should be provided (e.g., shown or otherwise output) as augmentations: digital compass input from a magnetic sensor; rotational data from a gyroscopic sensor; acceleration data from linear acceleration sensors; GPS data (latitude, longitude, altitude, and geodetic datum) from a GPS sensor; or image data from a video stream (which may itself include augmentations from other AR systems). The processing of this information is used to determine the real world viewing device's (e.g., camera's) position, orientation, and field of view (expressed as a frustum), and to estimate an accuracy of that determination. For example, the one or more processors may determine a viewing device's (e.g., camera's) six-dimensional location. Location may be the set of latitude, longitude, altitude, geodetic datum, and orientation, or include some combination of these. Orientation may be determined as a combination of angles, such as a horizontal angle and a vertical angle. Alternatively, orientation may be determined according to rotations, such as pitch, roll, and yaw.

GPS data along with digital compass and gyroscopic sensor data may be used at a given moment to determine the 3D location and orientation of a camera that is co-located with the relevant sensors. The resulting real world frustum may then be applied to a 3D virtual representation (a virtual world). Corrective algorithms may be used during or after the applying step 323. For instance, if a putative augmentation is not be exactly positioned on or adjacent to an object which appears in the real world content, a procedure may be executed which “snaps” the augmentation to the nearest object detected in the image.

Based on the real world viewing device's (e.g., camera's) frustum, and on the detected placement of any relevant image data in the image, augmentations may be displayed as sourced from the 3D virtual representation (a virtual world), as modified by characteristics associated with that representation, and potentially adjusted due to detected image data. Augmentations may be visual and/or may be audial or tactile, for example.

Some embodiments of the present invention may be a system, a device, a method, and/or a computer program product. A system, device, or computer program product may include a computer readable storage medium (or media) having computer readable program instructions thereon for causing a processor to carry out aspects of the present invention, e.g., processes or parts of processes or a combination of processes described herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Processes described herein, or steps thereof, may be embodied in computer readable program instructions which may be paired with or downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions and in various combinations.

These computer readable program instructions may be provided to one or more processors of one or more general purpose computers, special purpose computers, or other programmable data processing apparatuses to produce a machine or system, such that the instructions, which execute via the processor(s) of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the invention has been described herein in connection with exemplary embodiments and features, one skilled in the art will recognize that the invention is not limited by the disclosure and that various changes and modifications may be made without departing from the scope of the invention as defined by the appended claims.

I claim:

1. A computer-implemented method for modifying a sensory modality which is perceived by a user for a reality mediated by a virtual reality (VR) or augmented reality (AR) device, comprising
determining a first viewing frustum of a first reality;
aligning the first viewing frustum of the first reality with a second viewing frustum of a second reality; and
while maintaining the alignment of the first and second viewing frustums, changing the sensory modality perceived by the user for one or more objects of the first reality to conform with the second reality.

2. The computer-implemented method of claim 1, wherein the first reality is UR or AR and the second reality is AR or VR.

3. The computer-implemented method of claim 1, wherein the first reality is AR or VR and the second reality is UR or AR.

4. The computer-implement method of claim 1, wherein the step of aligning includes matching the following parameters of the first and second frustums: a position, a vertical field of view, a horizontal field of view, a near limit, and a far limit.

5. The computer-implemented method of claim 1, wherein the changing step comprises changing an appearance of a real object to a quasi-real object.

6. The computer-implemented method of claim 1, further comprising, after the first changing step, a second changing step comprising changing an appearance of the quasi-real object to an unreal object.

7. The computer-implemented method of claim 1, further comprising changing the second reality to a different perspective after the first and second changing steps.

8. A method of altering a user's perception of reality, comprising
displaying at a first time an augmented reality (AR) comprising both real world content and virtual content;
displaying at a second time a virtual reality (VR) consisting only of virtual content; and
between the first time and the second time, seamlessly transitioning from the AR to the VR.

9. The method of claim 8, wherein the step of seamlessly transitioning comprises
determining a real world viewing frustum of one or more user's at the first time;
applying the real world viewing frustum to a virtual model configured to correspond with the real world so that at least some virtual objects spatially align with real objects; and
switching display from AR to VR after the alignment of the applying step.

10. The method of claim 9, further comprising changing a vantage point of the one or more user's after the switch from AR to VR.

11. The method of claim 10, wherein the step of changing a vantage point comprises beginning with a first person ground view and transitioning to a third person aerial view in the VR.

12. A method of altering a user's perception of reality, wherein the first perception of reality is an unmediated reality (UR), comprising
determining a real world viewing frustum of the user;
applying the real world viewing frustum to a virtual model configured to correspond with the real world so that at least some virtual objects spatially align with real objects;
substituting at least some real content with corresponding pseudo-real virtual content from the aligned virtual objects of the virtual model; and
outputting an AR output that includes the pseudo-real virtual content.
